(19) United States
(12) Patent Application Publication
(10) Pub. No.: US 2017/0213536 A1
(43) Pub. Date: Jul. 27, 2017

(54) WHISTLE

(71) Applicant: Wan Sheng YU, Taichung (TW)

(72) Inventor: Wan Sheng YU, Taichung (TW)

(21) Appl. No.: 15/007,407

(22) Filed: Jan. 27, 2016

(51) Int. Cl. G10K 5/00

(52) U.S. Cl. CPC G10K 5/00

(57) ABSTRACT

A whistle includes a housing having a chamber, and having a mouthpiece extended from the housing for engaging with a mouth of a user, the housing includes a partition provided in the chamber for separating the chamber the housing into two compartments, and includes two openings communicating with the compartments of the housing respectively, and includes one or more channels communicating with the compartments and the openings of the housing respectively, and two peas are received and engaged in the compartments of the housing respectively for generating sounds of different pitches and/or tones. The peas include different shapes, or the peas include different diameters.

### BACKGROUND OF THE INVENTION

1. Field of the Invention

The present invention relates to a signaling device or whistle, and more particularly to a signaling device or whistle including an improved and simplified structure or configuration that may be easily and quickly made or manufactured with a simplified making or manufacturing procedure and that may include a greatly increased manufacturing cost.

2. Description of the Prior Art

Various kinds of typical whistles or signaling devices have been developed and provided for generating a signal sound and the like and normally comprise a housing having a chamber formed therein for receiving or engaging with a cork pea, and an air passage formed in the end of the housing for producing a signal sound which helps draw attention.

For example, U.S. Pat. No. 4,314,316 to Gertler et al., U.S. Pat. No. 5,546,887 to Cameron, U.S. Pat. No. 7,992,513 to Shishido, and U.S. Pat. No. 8,006,634 to Shishido disclose several of the typical whistles or signaling devices each also comprising a chamber formed in a receptacle or the like for receiving or engaging with a cork pea, and for producing a signal sound when an air is blowing through an air passage that is formed in the end of the receptacle.

However, the typical whistles or signaling devices includes a complicated structure or configuration that may not be easily and quickly made or manufactured and that may include a complicated making or manufacturing procedure and that may include a greatly increased manufacturing cost.

The present invention has arisen to mitigate and/or obviate the afore-described disadvantages of the conventional whistles or signaling devices.

### SUMMARY OF THE INVENTION

The primary objective of the present invention is to provide a whistle including an improved and simplified structure or configuration that may be easily and quickly made or manufactured with a simplified making or manufacturing procedure and that may include a greatly increased manufacturing cost.

In accordance with one aspect of the invention, there is provided a whistle comprising a housing including a chamber formed therein, and including a mouthpiece extended from the housing for engaging with a mouth of a user, the housing including a partition provided in the chamber thereof for separating the chamber the housing into two compartments, and including two openings formed therein and communicating with the compartments of the housing respectively, and including at least one channel formed therein and communicating with the compartments and the openings of the housing respectively, and two peas received and engaged in the compartments of the housing respectively for generating sounds of different pitches and/or tones.

The housing includes two swellings provided on an upper portion of the mouthpiece, and/or the housing includes two bulges provided on a lower portion of the mouthpiece to form the mouth grip structure for suitably engaging with the mouth of the user and thus for allowing the whistle to be solidly and stably positioned and anchored or retained in the mouth of the user. The peas include different shapes, and/or the peas include different diameters.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a whistle in accordance with the present invention;

FIG. 2 is a top plan schematic view of the whistle;

FIGS. 3, 4 are top plan schematic views similar to FIG. 2, illustrating the other arrangement of the whistle;

FIG. 5 is a side plan schematic view of the whistle;

FIG. 6 is a cross sectional view of the whistle, illustrating the operation of the whistle;

FIG. 7 is a another perspective view similar to FIG. 1, illustrating the other arrangement of the whistle; and

FIG. 8 is a top plan schematic view of the whistle as shown in FIG. 7.

### DETAILED DESCRIPTION OF THE PREFERRED EMBODIMENT

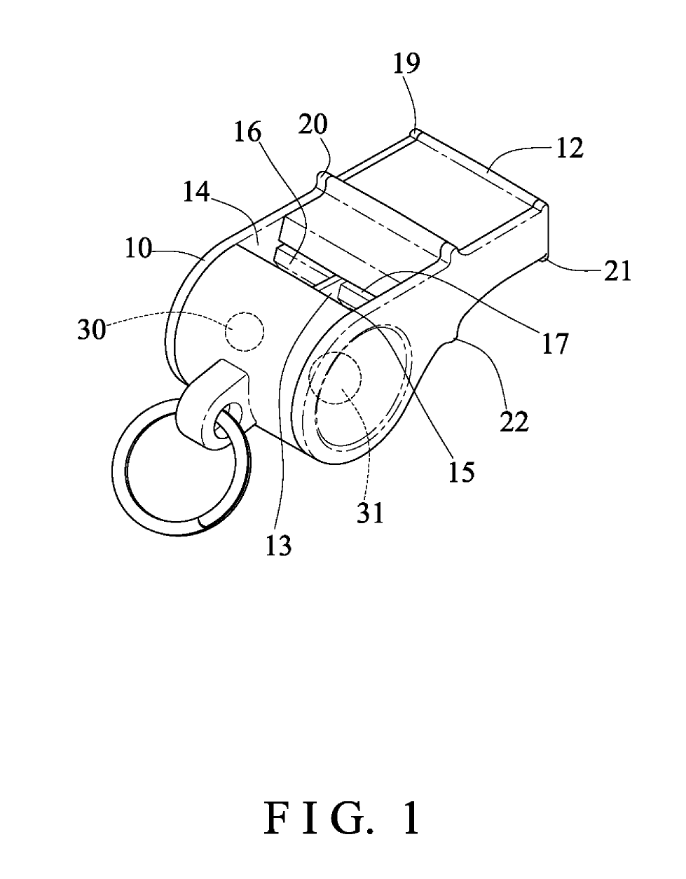

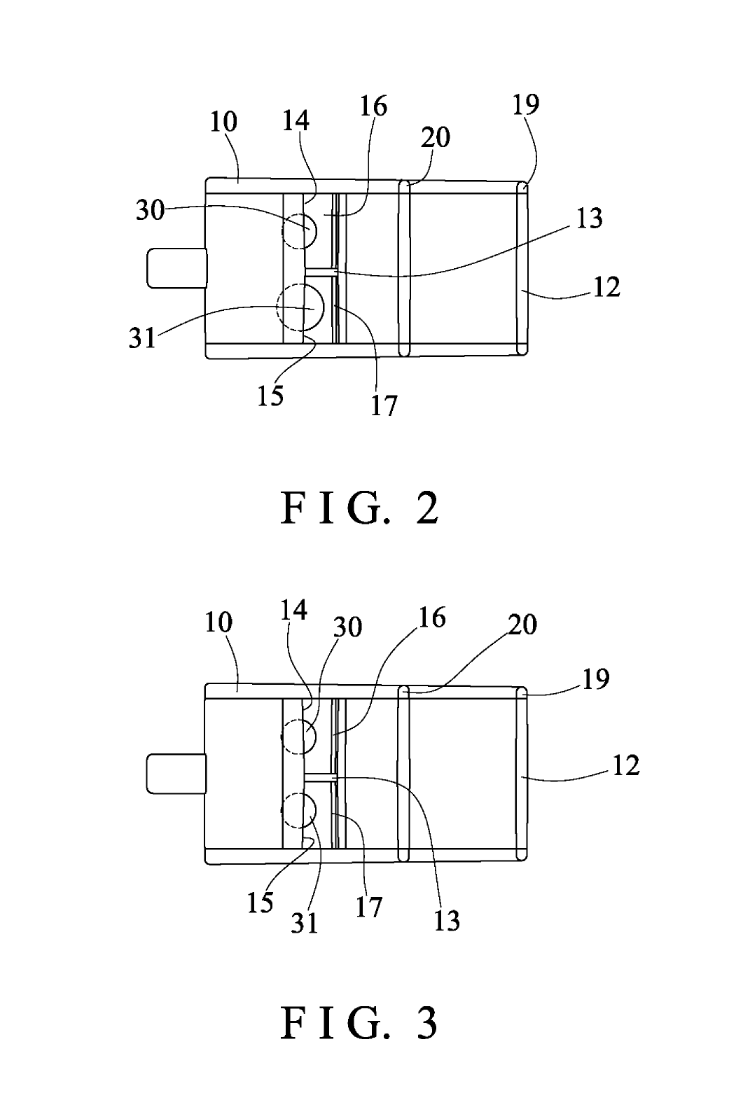

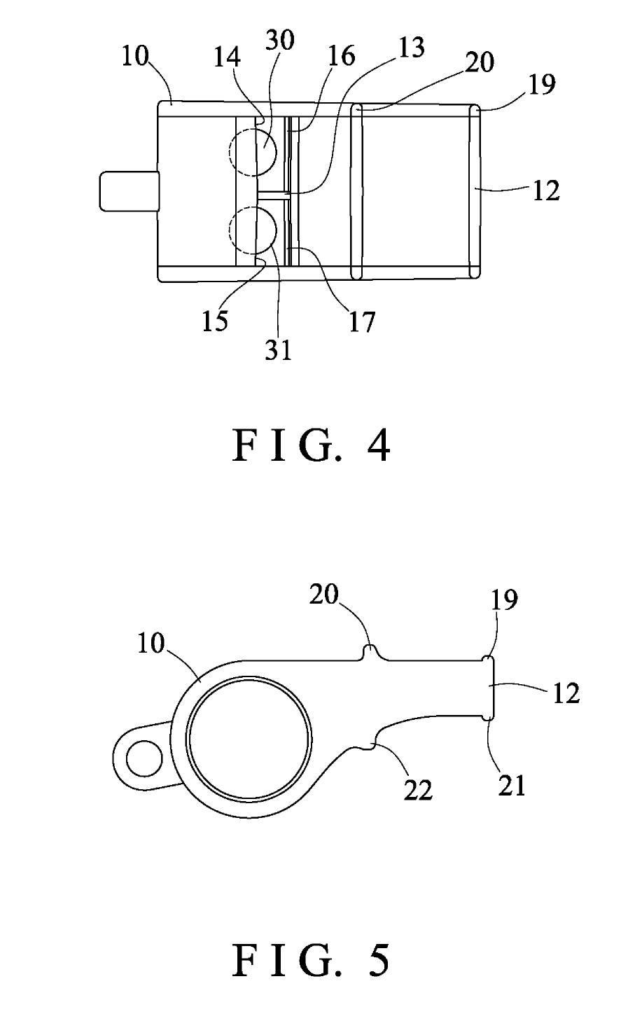

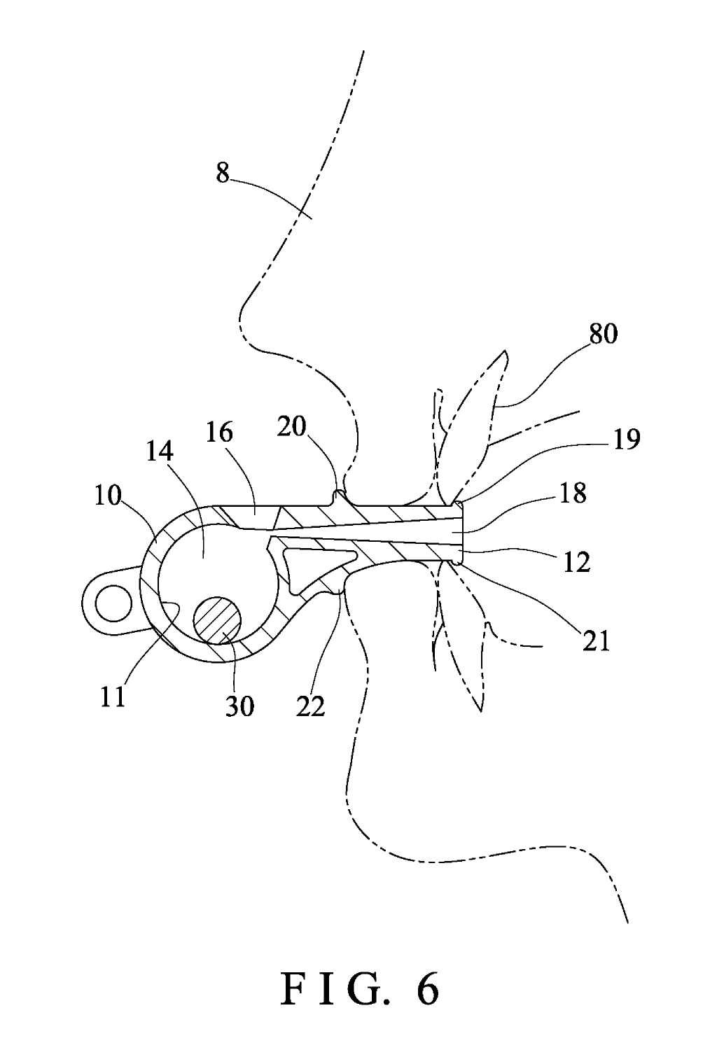

Referring to the drawings, and initially to FIGS. 1-6, a whistle in accordance with the present invention comprises a receptacle or drum-shaped body portion or housing 10 including a chamber 11 formed therein (FIG. 6) for receiving or engaging with one or more (such as two) peas 30, 31 therein, and a tapered mouthpiece 12 extended from the housing 10 for engaging with the mouth 80 of a user 8 (FIG. 6) so that the user 8 can blow through it and emit an audible signal.

The housing 10 includes a partition 13 formed or provided therein for spacing or separating the chamber 11 the housing 10 into two compartments 14, 15 and for receiving or engaging with the peas 30, 31 respectively, and includes two openings 16, 17 formed therein and communicating with the compartments 14, 15 respectively, and further includes one or more (such as two) channels 18 formed therein and communicating with the compartments 14, 15 and/or the openings 16, 17 respectively, for allowing the user 8 to blow the air through the channels 18 and to escape through the openings 16, 17 thereof so as to produce the desired whistle tones.

As shown in FIGS. 1-4, the peas 30, 31 may be made or formed of different shapes, diameters or standards or sizes or the like for generating sounds of different pitches and/or tones. The peas 30, 31 are made or formed of acrylonitrile butadiene styrene (ABS), poly propylene (PP), plastic, copper, metal, zinc alloy, aluminum alloy, or other suitable material that will not absorb water or humidity. It is to be noted that the cork peas for the typical whistles or signaling devices are normally made of cork or cotton fibers which may absorb water or humidity such that weight of the cork peas may be greatly increased after use and such that the sound generated by the typical whistles or signaling devices may be changed.

It is preferable that the housing 10 further includes one or more (such as two) ribs or swellings 19, 20 formed or provided on the upper portion of the mouthpiece 12, and one or more (such as two) swellings or bulges 21, 22 formed or provided on the lower portion of the mouthpiece 12 to form the mouth grip structure for suitably engaging with the mouth 80 of the user 8 and thus for allowing the whistle to be solidly and stably positioned and anchored or retained in the mouth 80 of the user 8.

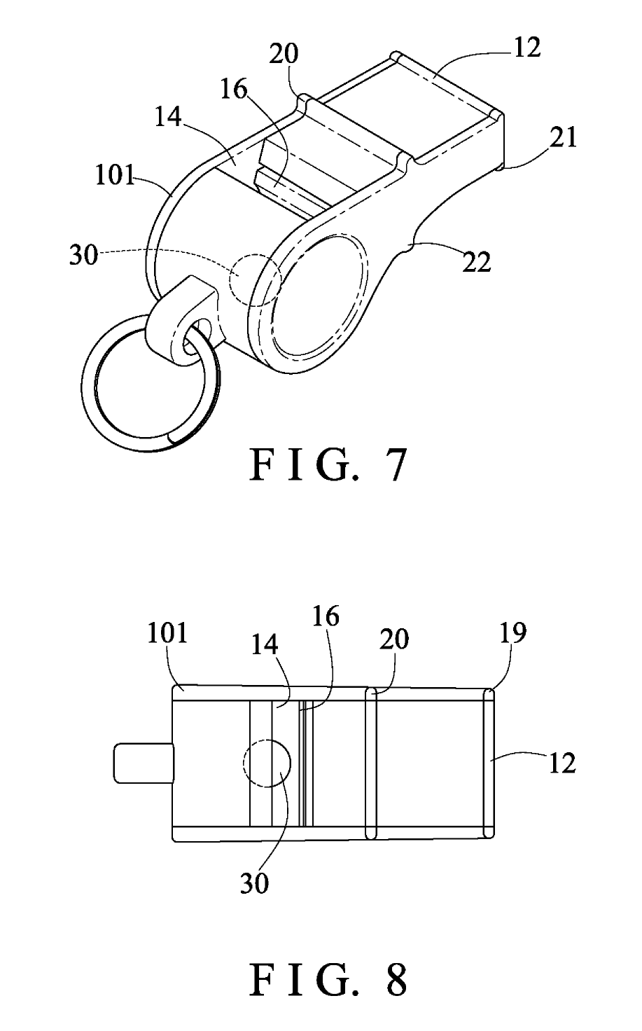

Alternatively, as shown in FIGS. 7 and 8, the housing 101 may include a single compartment 14 formed therein for receiving or engaging with a single pea 30, and may include a single opening 16 formed therein and communicating with the compartment 14, and may also include one or more (such as two) ribs or swellings 19, 20 formed or provided on the upper portion of the mouthpiece 12, and one or more (such as two) swellings or bulges 21, 22 formed or provided on the lower portion of the mouthpiece 12 to form the mouth grip structure for suitably engaging with the mouth 80 of the user 8 and thus for allowing the whistle to be solidly and stably positioned and anchored or retained in the mouth 80 of the user 8.

Accordingly, the whistle in accordance with the present invention includes an improved and simplified structure or configuration that may be easily and quickly made or manufactured with a simplified making or manufacturing procedure and that may include a greatly increased manufacturing cost.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A whistle comprising:
a housing including a chamber formed therein, and including a mouthpiece extended from said housing for engaging with a mouth of a user, said housing including a partition provided in said chamber thereof for separating said chamber said housing into two compartments, and including two openings formed therein and communicating with said compartments of said housing respectively, and including at least one channel formed therein and communicating with said compartments and said openings of said housing respectively, and
two peas received and engaged in said compartments of said housing respectively.

2. The whistle as claimed in claim 1, wherein said housing includes two swellings provided on an upper portion of said mouthpiece.

3. The whistle as claimed in claim 1, wherein said housing includes two bulges provided on a lower portion of said mouthpiece.

4. The whistle as claimed in claim 1, wherein said peas include different shapes.

5. The whistle as claimed in claim 1, wherein said peas include different diameters.
